(19) United States
(12) Patent Application Publication
(10) Pub. No.: US 2023/0009800 A1
(43) Pub. Date: Jan. 12, 2023

(54) PROGRAMMABLE INTEGRATED CIRCUIT USING A RADIOACTIVE SOURCE

(71) Applicant: COMMISSARIAT À L'ENERGIE ATOMIQUE ET AUX ENERGIES ALTERNATIVES, Paris (FR)

(72) Inventor: Jean-François MAINGUET, Grenoble (FR)

(73) Assignee: COMMISSARIAT À L'ENERGIE ATOMIQUE ET AUX ENERGIES ALTERNATIVES, Paris (FR)

(21) Appl. No.: 17/858,542

(22) Filed: Jul. 6, 2022

(30) Foreign Application Priority Data
Jul. 6, 2021 (FR) 2107304

(51) Int. Cl. G04F 5/16; H04L 9/08; H04L 9/00

(52) U.S. Cl. CPC G04F 5/16; H04L 9/0825; H04L 9/0894; H04L 9/50

(57) ABSTRACT

A programmable integrated circuit, including: at least one component that changes over time, changing autonomously within the integrated circuit, as a function of the time that has elapsed since an initialization phase of the integrated circuit, this change taking place by virtue of an internal radioactive source, at least one control circuit sensitive to the temporal change of the component and having at least one protected internal output that changes state only after a programmable predefined duration has elapsed since the initialization phase of the integrated circuit.

### TECHNICAL FIELD

The present invention relates to a programmable integrated circuit using a radioactive source.

### PRIOR ART

There are numerous applications where it would be of interest to provide information by setting a date prior to which it would remain concealed and inaccessible.

Historically, this was implemented with the aid of safes equipped with what are known as “time delay” locks, as recalled in the article Envoyer des messages à retardement [Sending messages with a delay] by Professor Delahaye, published in the journal Pour la Science, number 518, December 2020.

Since then, numerous scientists have sought equivalent solutions in the digital domain.

Some have thus proposed solutions consisting in encrypting information with a problem that is able to be solved only following computations that are estimated to require a minimum time to be performed. However, the progress of computers means that the time initially estimated to perform these computations may be significantly reduced. In addition, this solution is difficult to implement, expensive in terms of energy, and temporally imprecise.

Moreover, any solution based on a trusted third party is not fully satisfactory, in particular since it assumes that it is not possible to retrieve the information early from this trusted third party. However, said trusted third party may be subject to constraints obliging them to disclose the information.

Integrated circuits known as “real-time clocks”, or RTC, are also known, such as the one offered by ST under the brand Timekeeper Snaphat, which comprise a clock and an encapsulated lithium battery, giving a service life of the order of around ten years. However, these circuits are not designed to keep a secret.

Patents U.S. Pat. No. 9,530,529 or U.S. Ser. No. 10/083,771 have also proposed integrating radioactive sources into integrated circuits as a betavoltaic generator.

Patent U.S. Pat. No. 7,476,865 proposes to slave a clock to a radioactive source, and uses a ⁶³Ni source arranged close to a reverse-biased photodiode used as detector. A description is given of locking a local oscillator onto a system using radioactive decay, making use of the fact that the rate of decay is constant if the half-life is long. The 100-year half-life of ⁶³Ni makes it possible to consider, in this prior-art patent, that the radioactivity level is constant for the result that is sought.

Random number generators based on the use of radionuclides, as described in U.S. Ser. No. 10/708,044 or JP10142340, are also known.

### SUMMARY OF THE INVENTION

There is still a need to benefit from a solution that is relatively simple and inexpensive to implement for delaying the release of information or the execution of an action for a programmable predefined duration, possibly exceeding several years.

### SUMMARY OF THE INVENTION

The invention aims to meet this need, and it does so, according to a first of its aspects, by proposing a programmable integrated circuit, comprising:
at least one component, called “component that changes over time”, changing autonomously within the integrated circuit, as a function of the time that has elapsed since an initialization phase of the integrated circuit. this change taking place by virtue of an internal radioactive source,
at least one control circuit sensitive to the temporal change of said component and having at least one protected internal output that changes state only after a programmable predefined duration has elapsed since the initialization phase of the integrated circuit.

Preferably, the component that changes over time comprises a diode that is subjected to the radiation from the source, the radioactive source in particular being deposited on or close to the diode, or even inside it.

By virtue of using a radioactive source internal to the integrated circuit, it is possible to utilize the radiation produced by this source in two ways.

The first way consists in utilizing the decrease in activity over time, and in detecting the time at which this drop in activity corresponds to a predefined duration having elapsed.

The second way consists in utilizing the activity of the source to produce electrical energy for supplying power to an internal electronic clock.

i) Use of the Decrease in Activity of the Source as a Measure of the Elapsed Time

Component that Changes Over Time

The radioactive source is used within the component for its properties of decreasing activity over time.

In this case, it is associated with a detector sensitive to its radiation and configured to deliver a signal representative of its activity.

The decrease in activity is an intrinsic property of the material of the source and takes place without requiring any energy supply external to the integrated circuit; external energy may be supplied for programming the integrated circuit and reading the activity of the source if necessary.

Radioactive Source

The integrated circuit in this case comprises at least one radioactive element chosen based on its half-life and the order of magnitude of the duration that it is desired to be able to program in the circuit.

The radioactive element may be chosen from among 63Ni, 3H, or even 210Po, or any other element having a half-life that does not exceed a few hundred years.

63Ni is very particularly suitable for producing an integrated circuit according to the invention used over a duration of between a few months and a few hundred years.

In some variants, the integrated circuit comprises multiple sources with different half-lives, in order for example to increase precision or to allow a wider range for programming the duration.

The radioactive source may also be used to supply power to the integrated circuit, or the latter comprising a radioactive source intended to supply electric power thereto, in order for example to have fully autonomous operation of the integrated circuit. The initial activity of the radioactive source may be less than or equal to 10 MBq.

Detector

The detector that is used is preferably a semiconductor detector. The component that changes over time preferably comprises a PN or PIN junction, in particular a PIN diode.
The radioactive source is preferably deposited on or close to the diode, but it may also be implanted within the depletion region. When the radioactive source is made of metal, an electrical insulator may be interposed between the source and the diode so as not to short-circuit it.
The detector may, as a variant, comprise a scintillator, if the bulk of the integrated circuit allows this, or other types of detector, such as for example a CdTe detector.

ii) Use of the Energy of the Radiation to Supply Power to the Integrated Circuit

Component that Changes Over Time

In this case, the radioactive source is used so as to produce electricity, and the electricity that is produced is used to make a clock internal to the integrated circuit, and also preferably the control circuit, operate autonomously.

Said component thus preferably comprises:
At least one internal energy source;
At least one clock circuit supplied with power by the internal energy source.

The internal energy source preferably comprises at least one radioactive source and a production circuit for producing electrical energy from the source.

With the integrated circuit having available the energy produced by the radioactive source to make the internal clock operate autonomously, the component that changes over time may change without requiring any energy supply external to the integrated circuit.

The internal clock is preferably capable of generating pulses with a fixed duration in a repeatable manner.

Radioactive Source

Nuclear batteries, in particular betavoltaic ones, are known per se, and the radioactive source according to this variant of the invention may be implemented in a similar manner.

Reference may be made for example to U.S. Pat. No. 9,530,529, which describes a method for fabricating a semiconductor radioisotope battery, or to patent U.S. Ser. No. 10/083,771 (“Radioisotope power source embedded in electronic devices”).

Use is preferably made of a radioactive element emitting beta radiation, for example chosen from among tritium or 63Ni, among other possibilities.

This source may be associated with a PN junction, in particular a PIN diode, so as to produce electricity.

Hereinafter, the radioactive source may be used in accordance with i) or ii).

Memory

The integrated circuit may comprise at least one protected non-volatile memory read access to which is possible only when the internal output of the control circuit is in a predefined state.

This memory may contain information that it is desired to conceal for a predefined duration or at least one key needed to decrypt the information that it is desired to conceal.

This memory may also contain a code intended to be executed when the internal output of the control circuit changes state, after the programmed duration has elapsed.

In case i) above in particular, the memory may also contain a value representative of the initial activity of the radioactive source and/or of the target activity of the source, with which the activity at a given time is compared in order to determine whether a predefined duration has elapsed.

The memory may be of various types, in particular a type chosen from among EPROM, Flash, PROM, EEPROM, UVPROM, SSD, CBRAM, FeRAM, Millipede, MRAM, holographic memory, NRAM, PRAM, RRAM3D, or XPoint.

The memory may be associated with what is known as a “fuse” circuit, which allows an initial write operation to the memory in an initialization phase and which may then be activated so as to prevent any external access to and modification of the information stored in the memory.

The circuit may comprise a fuse for deactivating at least one input of the circuit for programming the predefined duration.

Control Circuit

Preferably, in particular in case i) above, the control circuit comprises:
at least one readout circuit for reading the radioactivity level of the source,
at least one comparator for comparing the read radioactivity level with a target level and generating a change of state of the protected internal output only when the radioactivity level is below the target level, due to the natural decrease in the activity of the source.

The target level is determined when programming the integrated circuit and is not modifiable thereafter.

When the radioactive source is used in accordance with i), the control circuit preferably comprises a computing circuit for computing the target level from a date or duration given at input and the level of the source at the time when the target level is defined.

When the radioactive source is used in accordance with ii), the control circuit preferably comprises a computing circuit for converting a date or a period at input into a corresponding reference number of pulses of the clock circuit, the clock circuit being designed to count the number of clock pulses that have elapsed since the initialization phase, the control circuit comparing the elapsed number of pulses with the reference number. The clock circuit is for example produced in a conventional manner with a quartz oscillator.

Security Means

The integrated circuit may comprise security means of various orders.

First of all, the circuit may comprise means that prevent it from being reprogrammed, such as a fuse, for example, which is activated after the initial programming.

The circuit may comprise physical shielding means aimed at protecting it from local radioactivity, for example shielding made of lead, from electromagnetic attacks, for example electrical shielding, or from physical attacks on the circuit, for example a snaking conductor track that covers certain regions of the circuit and that is intended to break in the event of said circuit being opened, the circuit being designed to no longer operate in the event of the track being broken.

The circuit may also comprise one or more environment sensors, such as temperature, voltage or radiation sensors, in order to detect abnormal read or operating conditions of the circuit, and in this case generate a warning or any other predefined measure, for example barring read access to the secret programmed in the circuit.

Example with Multiple Secrets

In one exemplary embodiment, the integrated circuit comprises at least first and second radioactive sources having different half-life durations, a first control circuit comprising:
at least one readout circuit for reading the radioactivity level of the first radioactive source,
at least one comparator for comparing the read radioactivity level with a first target level and authorizing a change of state of a first internal output, in particular authorizing the reading of a first secret, only when the radioactivity level is below the first target level, due to the natural decrease in the activity of the first source,

and a second control circuit comprising:

at least one readout circuit for reading the radioactivity level of the second source,

at least one comparator for comparing the read radioactivity level with a second target level and authorizing a change of state of a second internal output, in particular authorizing the reading of a second secret, only when the radioactivity level is below the second target level, due to the natural decrease in the activity of the second source.

As a variant, the circuit comprises for example at least one radioactive source, at least one readout circuit for reading the radioactivity level of the source, a first control circuit comprising at least one comparator for comparing the read radioactivity level with a first target level and authorizing a change of state of a first internal output, in particular authorizing the reading of a first secret, only when the radioactivity level is below the first target level, due to the natural decrease in the activity of the source,

and a second control circuit comprising at least one comparator for comparing the read radioactivity level with a second target level and authorizing a change of state of a second internal output, in particular authorizing the reading of a second secret, only when the radioactivity level is below the second target level, due to the natural decrease in the activity of the source.

Example with Multiple Comparisons

In another exemplary embodiment of the invention, the integrated circuit comprises at least one radioactive source and at least one readout circuit for reading the radioactivity level of the source, and
at least one comparator for comparing the read radioactivity level with a first target level and generating a corresponding internal output,
at least one comparator for comparing the read radioactivity level with a second target level and generating a corresponding internal output,

the control circuit being designed to authorize a predefined action, in particular the reading of a secret, only when the internal outputs of the first and second comparators are in predefined states.

Method for Protecting Information

Another subject of the invention is a method for protecting information for a predefined duration using an integrated circuit as defined above, comprising the steps of:
encrypting the information so as to allow it to be decrypted only in the presence of at least one decryption key,
storing said decryption key as a secret in the protected memory of the integrated circuit,
programming said circuit with the predefined duration.

Method for Performing a Predefined Action after a Given Duration

Another subject of the invention is a method for performing a predefined action after a period or a programmed date, comprising the following steps:
storing, in an integrated circuit according to the invention, a period or a date or a corresponding target level after which an action should be performed,
performing said action when the internal output of the circuit changes state once the date has been reached or the period has elapsed and the read radioactivity level has crossed the corresponding target level.

This action is for example an electronic transaction, unlocking an electronic appliance or access to a document, displaying information, unlocking the option to perform another action, opening a safe, activating a program, among other examples.

The predefined action may thus be the activation of a bank card or another chip card, so as to allow this card to be used by a user only after a predefined period or date D and/or before a predefined period or date D. This period is for example the one before the expiry of a bank card already held by the user, or a date following the expected date of receipt of a postal package containing said card. Another predefined action may be the deactivation of a bank card on the expiry date inscribed on the card.

The predefined action may also be an action of activating an application loaded into an electronic device, in particular a mobile telephone, so as to allow this application to be used by a user only after a predefined period or date D. For example, the application already lies in the device but is inactive before a given date, and activation thereof may for example correspond to a launch date of a new functionality for a set of users who own one and the same device.

The target level may be determined using computing means external to the integrated circuit.

It is additionally possible to authenticate a user of the circuit by checking the correspondence between a public key stored on the circuit and a private key held by the user, based on the result of this check, authorizing or not authorizing programming of the circuit.

The integrated circuit may receive a request and process this request based on the state of the internal output, in particular receive a random number and return a corresponding number that authenticates it for as long as the internal output is in a predefined state.

Another subject of the invention is a method for generating a blockchain, in which at least one action of validating a block depends on a predefined duration having elapsed within a circuit according to the invention.

This may make it possible to replace all or part of a proof of work with a proof of elapsed time, and thus address the need to reduce the energy consumption inherent to mining operations. The complexity of the mining computation is for example reduced by making the miner who performed this computation wait for a predefined waiting duration before being able to mine a new block. The circuit according to the invention may be used to guarantee that this duration has elapsed.

### BRIEF DESCRIPTION OF THE DRAWINGS

The invention will be able to be better understood upon reading the following detailed description of non-limiting exemplary implementations thereof, and upon examining the appended drawing, in which:

FIG. 1 partially and schematically shows one example of an integrated circuit according to the invention,

FIG. 2 partially and schematically shows some details of the component that changes over time of the integrated circuit of FIG. 1,

FIG. 3 partially and schematically shows one example of a diode able to be used to form the component that changes over time,

FIG. 4 partially and schematically illustrates one example of a readout circuit according to the invention,

FIG. 5, FIG. 6, FIG. 7A, FIG. 7B and FIG. 7C, FIG. 8, FIG. 9, FIG. 10, FIG. 11 and FIG. 12 partially and schematically show variants of the integrated circuit of FIG. 1,

FIG. 13, FIG. 14 and FIG. 15 partially and schematically illustrate a variant of the integrated circuit of FIG. 1 in which the circuit is autonomous, and,

FIG. 16 partially and schematically shows another exemplary embodiment of an integrated circuit according to the invention.

### DETAILED DESCRIPTION

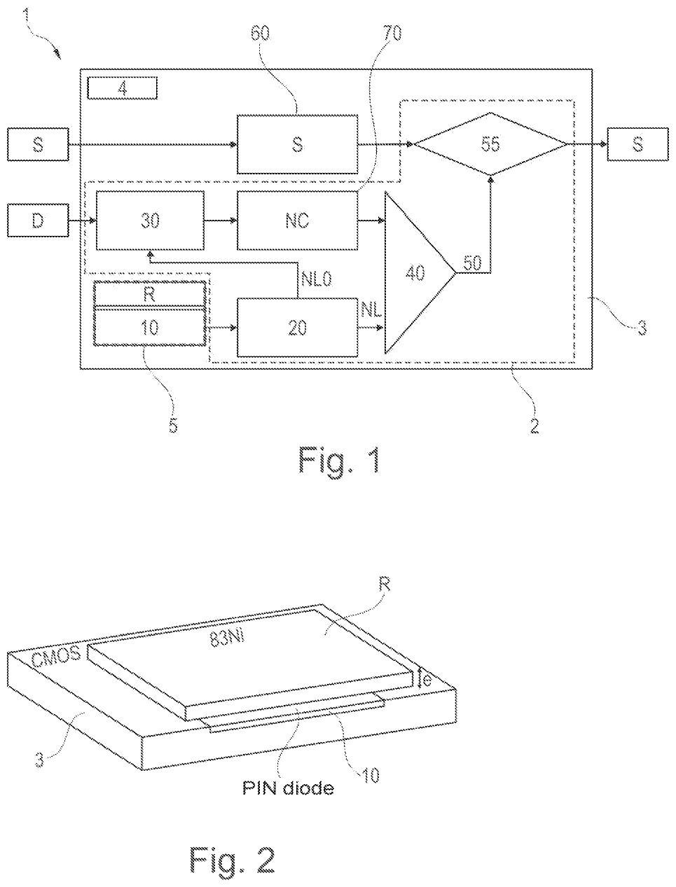

FIG. 1 illustrates one example of a programmable integrated circuit 1 according to the invention, produced for example in full on a single chip 3, for example using a CMOS technology.

The circuit 1 comprises a component that changes over time 5 that changes autonomously, as a function of the time that has elapsed since an initialization phase of the integrated circuit, and a control circuit 2 that makes it possible to measure the time that has elapsed and to trigger an action based on this measurement.

The change of the component 5 is said to be “autonomous” since it takes place here by virtue of the natural decay of a radioactive source R internal to the integrated circuit, and does not require any external energy supply. This radioactive source is for example ⁶³Ni.

The component 5 comprises a semiconductor detector, for example a diode 10, on which the material of the radioactive source R is deposited, as described further below.

In the example under consideration, the integrated circuit 1 is designed to store a secret S and a programmable period D, and the control circuit 2 blocks the reading of the secret S for as long as the period D has not elapsed starting from an initialization phase of the integrated circuit 1.

The secret S is stored in the initialization phase or before this in a non-volatile memory 60 of the integrated circuit 1. The secret S may then be protected from external observations by any appropriate means, for example with the aid of a fuse 4 that is blown so as to prevent the memory from being rewritten after it has been programmed and by optional shielding, known to those skilled in the art.

Other anti-intrusion or anti-attack protection means, known to those skilled in the art, may be added to the circuit 1. It is possible for example to add shielding to the circuit 1, such as a grid or active grid, and/or lead shielding against any external radioactivity sources, as described further below. It is also possible to use an additional device for detecting certain abnormal conditions, such as a temperature or voltage variation. It is also possible to scramble the information contained in the circuit 1 using conventional methods.

The control circuit 2 may comprise, as illustrated, a readout circuit 20 for reading the radioactivity level NL of the source R, a computing circuit 30 for computing a target level NC, and a memory 70 in which the target level NC thus computed is stored.

The memories 60 and 70 may be two separate memories or two blocks of one and the same memory.

The target level NC is not necessarily secret, but it is not modifiable externally once it has been stored in the memory 70. Provision may in particular be made within the integrated circuit for means for protecting it from modification, for example a fuse that is activated after the target level NC has been stored. This fuse may or may not be the same as the one that is used to bar access to the memory 60.

The control circuit 2 comprises a comparator 40 for comparing the read radioactivity level NL with the target level NC, and has a protected internal output 50 that changes state only when the result of this comparison changes, that is to say after the predefined duration D has elapsed and the read radioactivity level NL is below the target level NC.

In the example under consideration, this change of state is processed by a processing circuit 55, which triggers, as action, the reading of the memory block 60 and therefore the disclosure of the secret S, but, in some variants, other actions may be triggered, such as the execution of a code for example.

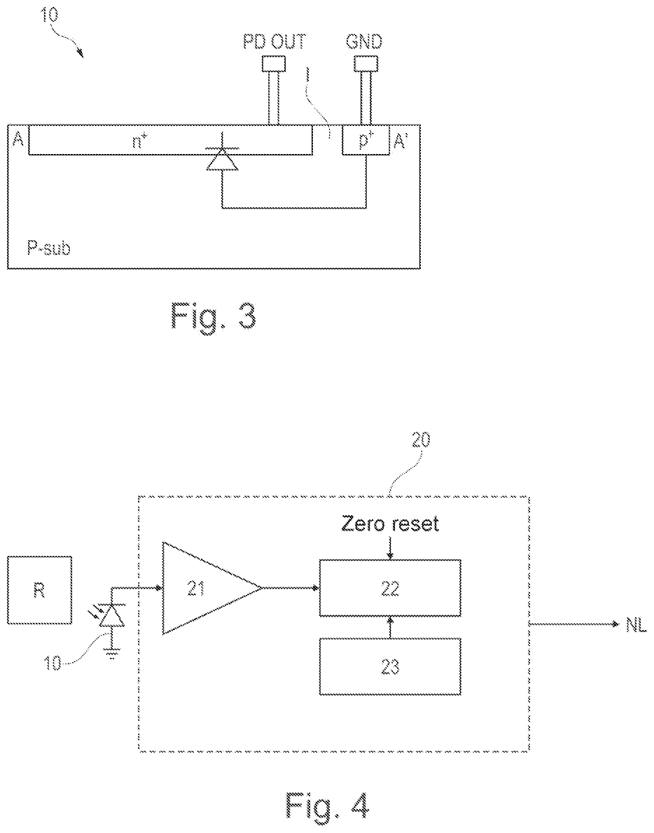

A description will now be given, with more particular reference to FIGS. 2 and 3, of the component that changes over time 5.

The diode 10 is for example fabricated directly on the chip 3 using CMOS technology. It may be formed vertically, as described in U.S. Pat. No. 9,530,529 or the article by Krasnov, Andrey, et al. “A nuclear battery based on silicon pin structures with electroplating 63Ni layer.” (Nuclear Engineering and Technology 51.8 (2019): 1978-1982).

It may also be formed horizontally, as described in patent U.S. Pat. No. 10,083,771.

As an alternative, the diode 10 may be fabricated separately and transferred onto the chip 3, as described in the article by Wyrsch, Nicolas, et al. “TMin-film silicon detectors for particle detection.” (physica status sohdi (c) 1.5 (2004): 1284-1291).

As an alternative, the diode 10 may be fabricated directly on the chip 3 by deposition.

The diode 10 has for example dimensions ranging from 100×100 μm² to 3×3 mm.

The radioactive source R is for example deposited on the surface of the diode 10 through electrolytic or chemical deposition. An electrical insulator may be added between the diode and the radioactive source.

The amount of radioactive material to be deposited, and in particular its thickness, depends on the efficiency observed in practice given certain parameters, for example the size of the diode 10, the read duration or else the effective radiation captured by the diode 10.

There is for example a ⁶³Ni source of thickness e of around 2.6 microns for a diode with dimensions 1×1 mm².

An insulating layer (not shown) may be added between the diode 10 and the radioactive source R in order to prevent short circuits when the radioactive source R conducts current.

The structure of the diode 10 is for example that of a PN or PIN diode, as illustrated in FIG. 3, which is reverse-biased and has an undoped or lightly doped I, for “intrinsic”, region arranged between two P+-doped and N+-doped regions.

The diode 10 may be encapsulated with the rest of the chip 3 in an encapsulating material for the integrated circuit, for example a resin or a ceramic, equipped with tabs or with pads for connection to external circuits. In order to protect the diode 10 from light so as not to interfere with the measurement, it may be covered if necessary with a shielding layer, in particular made of metal. It is possible for example to add a snaking conductor track that covers certain regions of the circuit and is intended to break in the event of said circuit being opened, the circuit being designed to no longer operate in the event of the track being broken.

The diode 10 that is thus produced and biased generates a current that is able to be read by the readout circuit 20 in order to determine the radioactivity level NL.

As shown in FIG. 4, the readout circuit 20 comprises for example an amplifier 21, followed by a pulse counter 22.

The counter 22 has a zero reset 220 and an authorization input 225 allowing state-based counting (for example, at zero, no count, and at one, the count is performed).

The measurement takes place for a predefined duration generated by a monostable circuit 23, this delivering a window with a fixed and repeatable duration in a precise manner, for example around one second. The monostable circuit 23 is connected to the authorization input 225 of the counter.

When a read operation is requested, for example upon receipt of an external signal, the readout circuit performs for example the following actions:
the counter 22 is reset to zero;
the monostable circuit 23 is triggered, authorizing the count of the events for a predefined duration;
once the duration of the monostable circuit 23 has elapsed, the count stops. A signal is generated indicating that the read operation has ended and that the result of the read operation is available.

The monostable circuit 23 preferably comprises temperature and voltage compensation so as to exhibit stability compatible with the desired precision, for example with a bandgap voltage reference for the voltage.

As described further above, it is also possible to use, as an additional protection means, one or more sensors for detecting an abnormal temperature and/or voltage variation.

The result of the read operation is a number NL that represents the radioactivity level of the source R.

For example, for a measured radioactivity level equal to 1000 for a ⁶³Ni source, the half-life of which is around 100 years, the same measurement will give 500 after a century has elapsed.

Preferably, the duration of the monostable is adjusted so as to measure a value that does not exceed the maximum count value of the counter. The amount of radioactive source R and therefore its activity may also be reduced for this purpose.

It is also possible to perform multiple successive read operations in order to average the read value, in order to reduce the effect of noise and of read or computing imprecisions.

Other readout electronics may be used, for example those disclosed in U.S. Pat. No. 7,476,865, comprising a charge sensitive amplifier followed by a signal shaping amplifier and a buffer.

The choice of the radioactive source R depends, inter alia, on the desired period D for the disclosure of the secret S and on the order of magnitude desired for the target level NC, which will be computed on the basis of this period.

The target level NC is computed based on the exponential radioactive decay formula known from the prior art, which gives the radioactivity level N of a radioactive element as a function of time:

N(t)=N(0)e^{-λt}

where λ=ln(2) is the half-life of the radioactive element under consideration, and N(0) is the initial radioactivity level, read in the initialization phase.

For example, for a ⁶³Ni radioactive source R, a period D of 200 years and a measured initial level NL N(0) of 1000 mean a computed target level NC of 250. For a period D of one year, the computed target level NC is around 993.

For even shorter periods, in particular of the order of a day, the target level NC may prove to be very close to the initial level and requires a precise count, larger amounts of radioactive product and/or a larger detector.

Use will then preferably be made of a radioactive element having a shorter half-life, for example tritium or polonium-210, among other examples.

The integrated circuit 1 may be used in two phases.

The integrated circuit 1 is first programmed before being able to be interrogated. The programming phase takes place in one go when the circuit is initialized. Said circuit may then be interrogated in line with the user's requirements.

During the programming phase, the secret S that is stored in the protected memory 60 is given at input.

The period D after which it is desired for the secret S to be disclosed is also given at input.

The readout circuit 20 reads the initial radioactivity level NL0 and transmits it to the computing circuit 30.

The computing circuit 30 computes the target level NC from the period D given at input and from the initial radioactivity level NL0.

This computation is for example performed using a microcontroller present on the 3, and/or using precomputed tables based on what has been described above.

The target level NC is then stored in the memory block 70.

In the example under consideration, the integrated circuit 1 additionally comprises a fuse 4, for example a write-once memory, that is to say one that is able to be written to only once.

Once the programming phase has ended, the fuse 4 is activated, thereby indicating that the integrated circuit 1 is no longer blank and has already been programmed. The initialization phase is then ended and the inputs for externally accessing the secret S and the period D to modify them are deactivated. It is no longer possible to externally access the target level NC in order to modify it. The activation of the fuse 4 also prevents external reading of the secret for as long as the duration D has not elapsed starting from the initialization phase, and may where appropriate also prevent reading of the target level NC and of the period D.

When the fuse 4 is activated, the only possible operation is an attempt to read the secret S. It is then sufficient to supply energy to launch the request and interrogate the integrated circuit 1.

In the phase of externally interrogating the integrated circuit 1, the readout circuit 20 reads the radioactivity level NL of the source R and transmits it to the computing circuit 30.

The read level is compared with the target level NC determined in the programming phase using the comparator 40, which performs for example a simple subtraction of the two values and observes the sign of the result.

If the read level NL is lower than the target level NC, then the period D has expired and the internal output 50 changes state. The integrated circuit 1 is designed such that this change of state allows external access to the memory 60 in order to read the secret S.

If the read level NL is higher than the target level NC, nothing happens.

The integrated circuit 1 according to the invention is not limited to the disclosure of a single secret S based on a single period D.

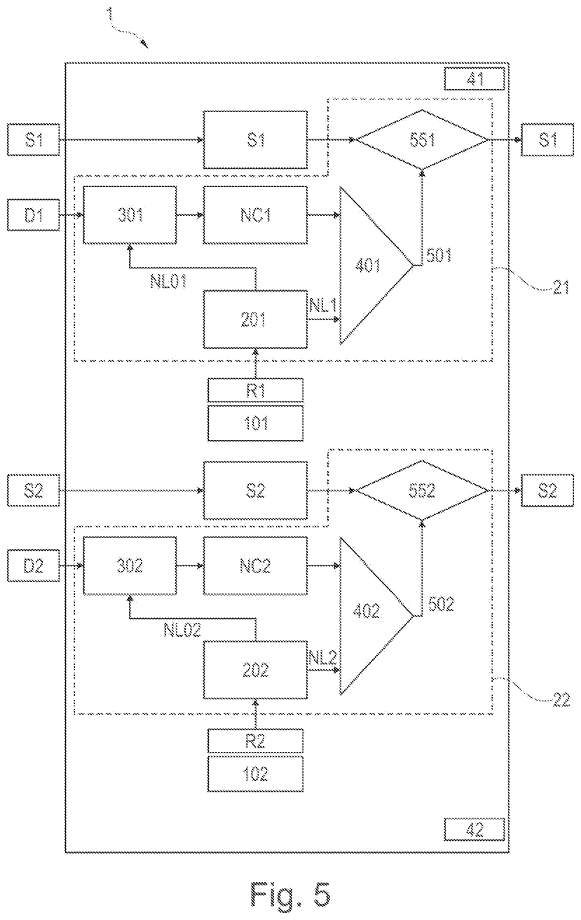

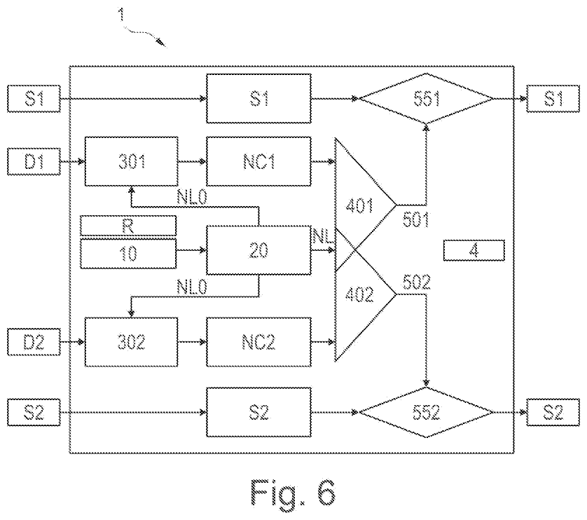

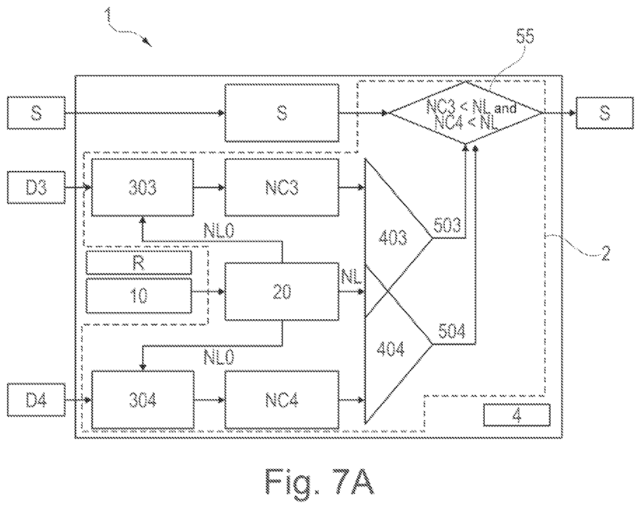

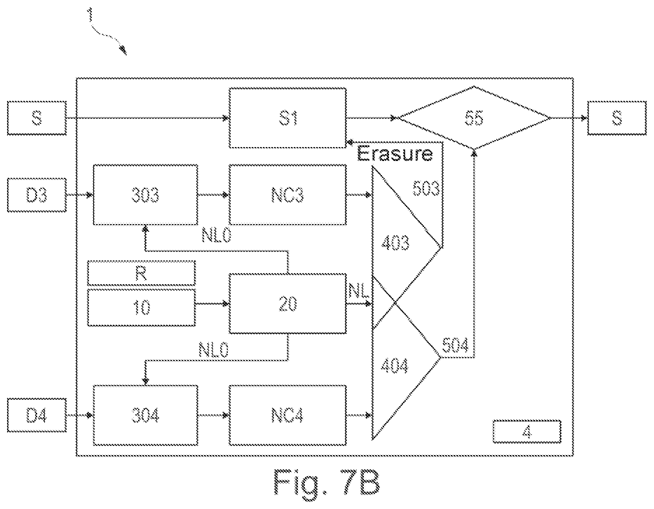

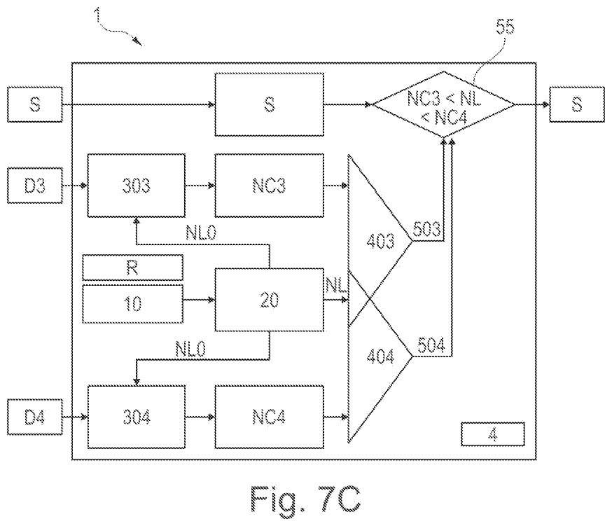

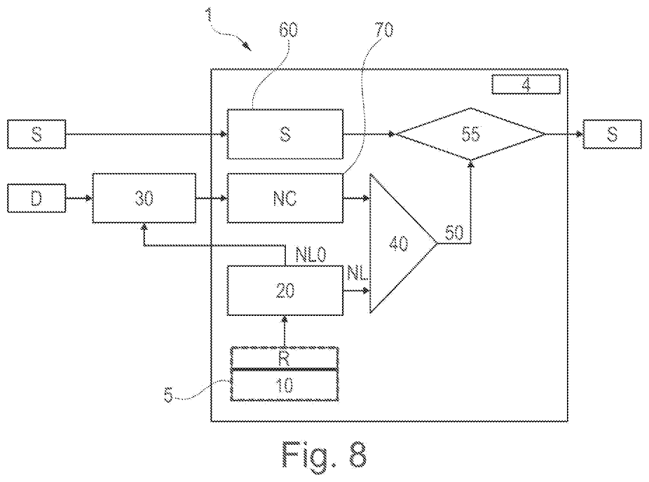

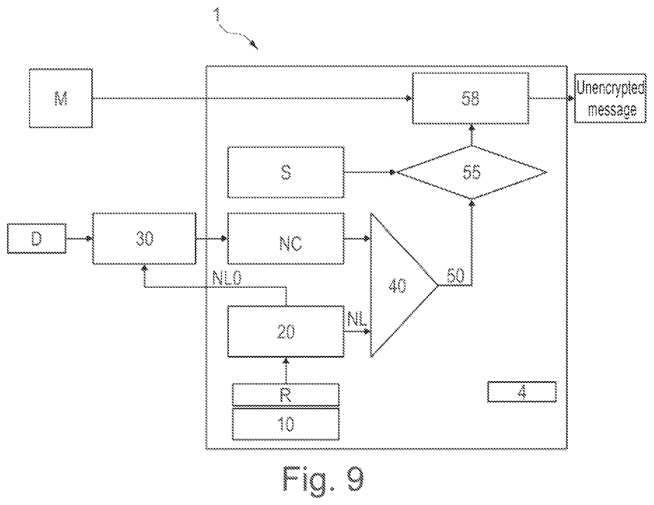

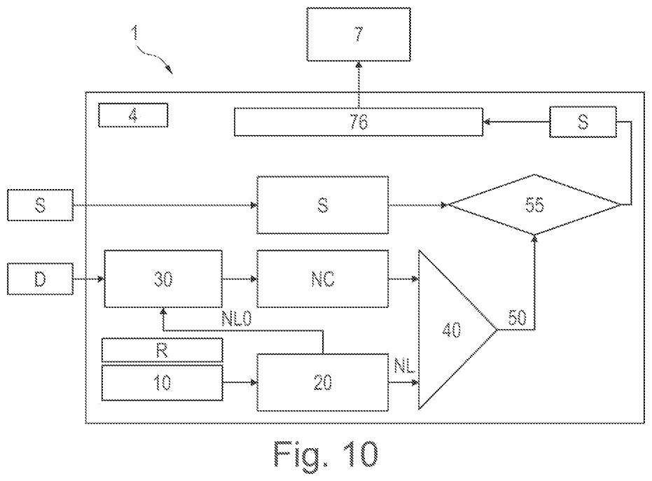

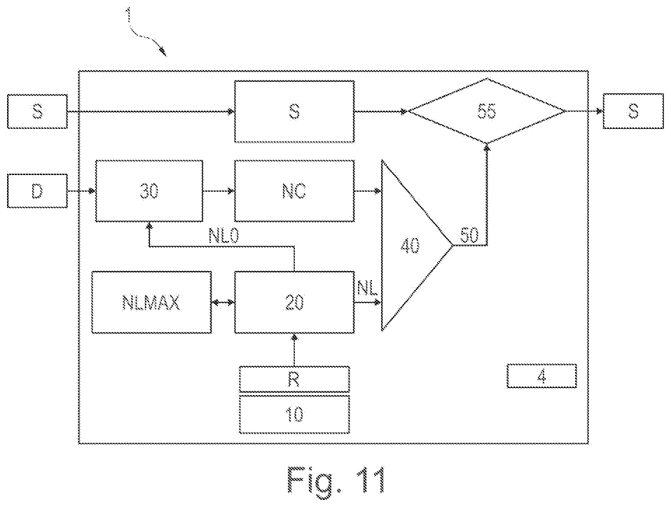

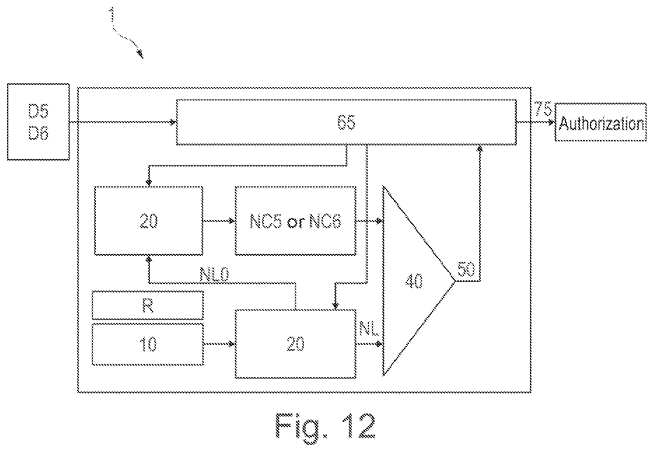

In the variant illustrated in FIG. 5, the integrated circuit 1 comprises two control circuits 21 and 22.

The first control circuit 21 is configured to block the reading of a first secret S1 for as long as a period D1 has not elapsed, while the second control circuit 22 is configured to block the reading of a second secret S2 for as long as a period D2 has not elapsed.

The control circuits 21 and 22 each comprise a radioactive source R1 and R2, respectively. Sources R1 and R2 that have different half-life durations are for example chosen, for example a nickel-63 source and a tritium source, thereby making it possible to adapt to longer or shorter periods.

The control circuit 21 (respectively 22) comprises the same elements as described above: a readout circuit 201 (respectively 202) that reads a radioactivity level NL1 (respectively NL2) of the source R1 (respectively R2), a computing circuit 301 (respectively 302) for computing a target level NC1 (respectively NC2), a comparator 401 (respectively 402) that compares the computed target level NC1 with the read reading level NL1 and generates an internal output 501 (respectively 502) that is sent to a processing circuit 551 (respectively 552) that authorizes the reading of the secret S1 (respectively S2) only when the radioactivity level is below the target level.

It is also possible to use a single component that changes over time 5 to disclose multiple secrets in accordance with the elapsed periods, as in the variant illustrated in FIG. 6 with two secrets S1 and S2 and two respective periods D1 and D2. In this example, two target levels NC1 and NC2 are computed in the programming phase and compared in the interrogation phase with the radioactivity level NL of the source R.

Each secret S1 or S2 is or is not disclosed separately depending on the result of the comparison of the levels NC1 and NC2 with the read level NL, respectively.

In the examples illustrated in FIGS. 7A to 7C, two periods D3 and D4 and a secret S are given at input.

The integrated circuit 1 comprises a control circuit 2 comprising two comparators 403 and 404 for comparing two target levels NC3 and NC4 with the radioactivity level NL of the source R.

In a first case, illustrated in FIG. 7A, the two periods have to have elapsed, that is to say the state changes of the two outputs 503 and 504 have to be generated, in order for the processing circuit 55 to allow the secret S to be disclosed. It is possible to choose different periods D3 and D4, or else identical periods and perform multiple comparisons in parallel, thereby making it possible to make the method for disclosing the secret more complex and therefore increase the security of the integrated circuit 1 against external attacks.

In the variant illustrated in FIG. 7B, the circuit 1 is programmed so as to erase the secret S if the period D3 is exceeded. For this purpose, the target level NC4 is defined as “authorization” target level and the target level NC3 is defined as “erasure” target level.

If the reading of the radioactivity level NL is performed once the period D4 has elapsed, the comparator 404 generates a change of state of the output 504, which is sent to the processing circuit 55 in order to authorize the disclosure of the secret S. However, if this reading is performed after the period D3 has elapsed, the comparator 403 generates a change of state of the output 503, which causes erasure of the secret S upstream of the processing circuit 55.

In order for the secret S to be disclosed, it is therefore necessary for the period D4 to have elapsed, but not the period D3, that is to say for the level NL to be below the target level NC4 and above the target level NC3.

The secret S is not erased when the period D3 has expired, but as soon as a read attempt is made, by supplying energy to the circuit 1 once the period D3 has elapsed. It is thus necessary to perform tests regularly in order to destroy the secret as early as possible if desired.

In the variant of FIG. 7C, the secret S is disclosed if the reading of the radioactivity level NL is performed once the period D4 has elapsed but before the period D3 has elapsed. The secret S is not erased once the period D3 has elapsed.

It is therefore simply checked whether

target level NC3<read level NL<target level NC4

in order to disclose or not disclose the secret S.

Other combinations are conceivable, according to requirements. It is possible for example to erase the secret S just after it is disclosed, thereby making it possible to bar multiple reading of the secret. It is also possible to block access to the circuit 1 for a certain duration after an access operation.

In one variant, the computing circuit 30 is embedded on means external to the integrated circuit, as illustrated in FIG. 8. Thus, in this example, the target level NC is computed separately during the initialization phase, and then stored in the memory 70, thereby making it possible to simplify the integrated circuit 1. The security of the computations performed by external means will preferably be ensured so as not to compromise the injected target level NC.

The secret S may correspond to any type of information.

In the example illustrated in FIG. 9, the secret S is a decryption key. This is not disclosed explicitly, as described in the previous examples, but use thereof is authorized once the period D has been exceeded.

The key S makes it possible for example to decode an encrypted message M given at input, using a decryption algorithm 58.

The invention is then for example integrated into a Trusted Platform Module (TPM) microcontroller as an additional function, thereby making it possible to release digital secrets after a determined duration.

This may be used for example to make payments that are staggered over time, by disclosing debit authorization on certain predetermined dates, or be used in procedures comprising multiple participants who all have to access a document or perform an action on a given date, for example for auctions, a vote, an examination or a competition.

The secret S may also be a password for opening a safe, thereby make it possible to have a safe with delayed opening that operates autonomously without any external energy supply.

Delayed access to the secret S also makes it possible to manufacture and distribute electronic devices, for example smartphones or video gaming consoles, that need to be unlocked with a code to operate, in order to allow operation thereof only at a given time, following its distribution, thereby streamlining the large-scale sale thereof.

Similarly, it may be decided to activate a particular application of a smartphone only after a certain period has elapsed by virtue of the invention, thereby making it possible in particular to avoid saturating servers at this time.

The invention is of course not limited to these exemplary applications. It is also possible to use the circuit according to the invention to program the activation of a bank card or any chip card, which is able to be used only after a chosen period D.

It is also possible to prevent a transaction from being duplicated by “freezing” the card for a predefined duration, in particular increasing durations, for example 1 minute, then 3 minutes, then 10 minutes, thereby hampering a thief if they wanted to use it repeatedly.

It is also possible to use the invention to sell lottery tickets in advance, said tickets already containing the winnings, which are disclosed only on a chosen date, without requiring a draw.

In the example illustrated in FIG. 10, an external display 7 is connected to the integrated circuit 1, for example an electronic paper display that is able to keep a display going without a power supply. The circuit 1 may then be configured to drive this display directly, for example using a driver circuit 76. As a variant, the display is driven by one or more external circuits.

Before the period D has elapsed, the display 7 displays for example the date when the secret will be released. During the interrogation, the user supplies energy (for example with a cell), thereby making it possible to update the display. Once the period D has elapsed, the secret itself may be displayed.

Concomitantly with the embedded display, it is possible to add to the integrated circuit a keypad or any other data entry device, for example a touchscreen, in order to have a fully autonomous and complete system.

Certain measures may be taken to protect the integrated circuit 1 from any attacks, for example a highly radioactive material that would be brought close to the system in order to interfere with the measurements of the radioactivity level NL.

This potential interference is particularly problematic if it occurs during the programming phase in the initial measurement of the radioactivity level NL and the determination of the target level NC resulting therefrom.

One possible countermeasure consists for example in adding shielding made of lead, or any equivalent material, to the integrated circuit 1 in order to reduce the effects of external radioactivity.

It is also possible to use a Geiger counter or the like at the time of programming to monitor local radioactivity. The computation of the target level NC may take into account, where applicable, the influence of this local radioactivity level and for example prevent the circuit 1 from being programmed for as long as the local radioactivity level is able to have a detrimental influence on the initial measurement of the radioactivity level NL.

It is also possible to add a check in the initial measurement of the radioactivity level NL, as illustrated in FIG. 11. At the time when the integrated circuit 1 is fabricated, in a secure/controlled environment, an initial test is for example performed in order to determine a maximum level NLMAX.

A second PIN diode may also be added to the circuit in order to monitor local radioactivity and prevent programming if necessary.

In the programming phase and during the interrogations, it is checked that all of the following radioactivity level NL measurements do not exceed this level NLMAX.

If this is not the case, the system for example stops working, or even self-destructs, for example by activating a fuse.

Other measures for protecting the secret are conceivable. It is possible to add a diode (not shown) that detects the light level to which the integrated circuit 1 is exposed and program the circuit to erase the secret if this level exceeds a certain threshold, the erasure taking place for example using the energy supplied by said light.

The examples described above require energy only at the time of reading of the radioactivity level NL. These are passive systems; in particular, the period D does not expire until a read attempt is made.

For some applications, it may be beneficial to have a circuit capable of actively monitoring the radioactivity level NL, in particular in order to spontaneously disclose the secret S as soon as the period D has elapsed.

In the example illustrated in FIG. 12, a barring period D5 and an authorization period D6 are given at input. The data are acquired by a system management algorithm 65, which allows the integrated circuit 1 to sustain itself by programming for example time ranges over which certain actions may be authorized.

Such a circuit operates for example as follows:
the barring duration D5 is sent to the computing circuit 30, which computes a first target level NC5,
at the same time, an authorization signal 75 is deactivated,
the radioactivity level NL is read regularly for as long as the target level NC5 is not reached, the comparator 40 returning the results of the comparison to the management algorithm 65,
once the radioactivity level NL is below the target level NC5, the management algorithm 65 sends the authorization duration D6 to the computing circuit 30, which computes a second target level NC6,
at the same time, the authorization signal 75 is activated,
the radioactivity level NL is read regularly for as long as the target level NC6 is not reached, the comparator 40 returning the results of the comparison to the management algorithm 65, and
the above steps are repeated.

Such operation requires the circuit to be supplied with power at all times, in particular by an external power source, in order to perform regular read operations on the radioactivity level NL.

It is possible for example to apply this operation to the opening of bank safes, or else to help to regulate an addiction to certain telephone applications, by programming the time ranges in which these applications are able to be used, and by preventing use thereof outside of these time ranges.

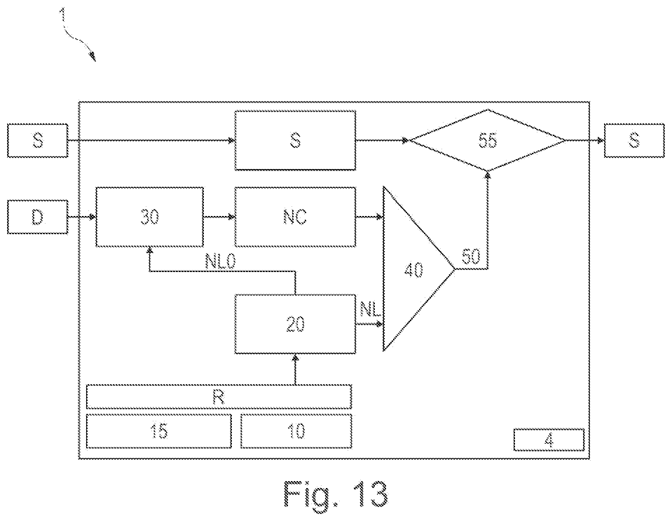

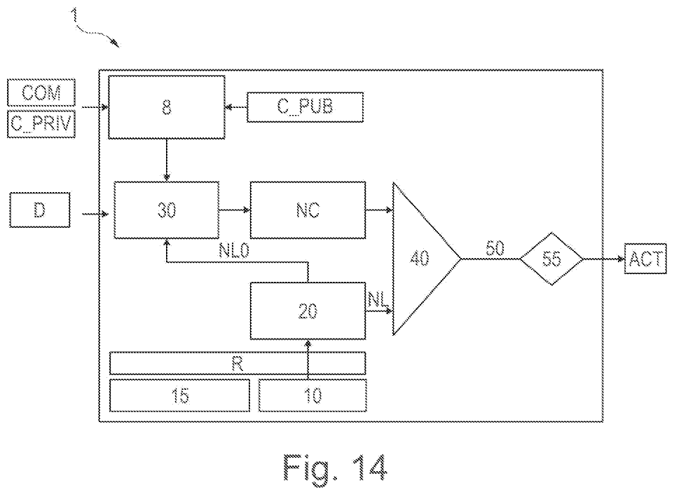

In the example illustrated in FIG. 13, the radioactive source R is used both as a clock and to produce electrical energy in order to supply power locally to the integrated circuit 1.

It is possible to use two depositions of a radioactive material within the same integrated circuit 1, each associated with a diode, specifically one diode 15 used to produce energy through emitted beta radiation for example, and one diode 10 to read the radioactivity level NL. As a variant, it is possible to use a single radioactive deposition and two diodes 10 and 15, for example each arranged on one side of this deposition, thereby potentially making it possible to increase compactness.

Such a system may then be fully autonomous in terms of its operation, this being advantageous for many applications, some of which will now be described with reference to FIGS. 14 and 15.

In the example illustrated in FIG. 14, the circuit 1 is programmed to perform a predefined action ACT once a period D has elapsed.

The circuit 1 may be secured by adding a public key C_PUB to the chip 3, the key C_PUB corresponding to a private key C_PRIV held by the user of the circuit 1. Thus, in the phase of programming the circuit 1, the user gives a command message COM at input, defining the action ACT to be performed and the period D, both encrypted with their private key C_PRIV. As a variant, the user gives the message COM and the period D in unencrypted form at input, along with the hash of the message COM obtained with a hash function and encrypted with their private key C_PRIV. The encryption with the private key makes it possible to sign the message, thus ensuring that the message actually comes from an authorized user holding the private key, which message is public since it is able to be deciphered by anyone with the available public key.

The circuit 1 comprises a checking circuit 8 that decrypts the message with the public key C_PUB or, according to the above variant, decrypts the encrypted hash and compares it with the hash of the message COM and the period D. The circuit 1 then activates or does not activate the programming of the circuit by authorizing the computing circuit 30 to compute the target level NC corresponding to the period D and to the initial radioactivity level NL0 read by the readout circuit 20.

Once the target level NC has been determined and stored, the radioactivity level NL is read at regular intervals, in particular by supplying power to the readout circuit 20 at all times using the radioactive source R, as described above.

When the period D has elapsed, the comparator 40 generates a change of state of the output 50, thereby leading the processing circuit 55 to trigger the action ACT to be performed, preferably via a protected link.

Once the circuit has been programmed, it is not possible to prevent the action ACT from being performed.

In the example illustrated in FIG. 15, an external system S is programmed not to perform an action ACT for as long as a condition is met, said condition depending on the output generated by the integrated circuit 1.

In the example under consideration, the action ACT to be performed is defined by a command message COM given at input of the system S. The system S may be secured, as illustrated, by a public key C_PUB corresponding to a private key C_PRIV that encrypts the message COM.

In this case, the system S comprises a checking circuit 8 decrypting the command message COM. Next, a random number generator 86 generates a random number NA_I, which is sent to the integrated circuit 1.

The system S expects in return a number NA_O corresponding to the number NA_I encrypted with the key C_PRIV, which the system S is able to decrypt with the public key C_PUB and check, through comparison with the sent number NA_I, that the order actually comes from a system that knows the private key C_PRIV. If it does not receive the expected random number (or does not receive anything) after a predetermined period, the action ACT is performed. Otherwise, a new random number NA_I is sent again.

The integrated circuit 1 is therefore programmed so as to choose the time at which the action ACT will be performed. A period D is given at input in the programming phase, thereby making it possible, as described above, to compute the target level NC based on the initial activity level NL0 of the radioactive source R read by the readout circuit 20.

The integrated circuit 1 comprises a non-volatile memory in which the private key C_PRIV is stored.

The processing circuit 55 is configured to send, to the system S, based on the private key C_PRIV, the expected encrypted number NA_O for as long as the internal output 50 of the comparator 40 has not changed state, that is to say for as long as the read level NL is above the target level NC.

Once the period D has elapsed, the read level NL drops below the target level NC and the comparator 40 generates a change of state of the internal output 50. The processing circuit, in response, does not send the encrypted number NA_O, and the action ACT is therefore performed.

The circuit 1 is supplied with power at all times, for example by the radioactive source R, and the receipt of the random number NA_I from the system S triggers the request to read the radioactivity level NL.

Once programmed, the integrated circuit 1 and the system S are fully autonomous, and it is not possible to prevent the action ACT from being performed.

The invention is not limited to a radioactive source the natural decay of which is used as a “clock” for the integrated circuit 1.

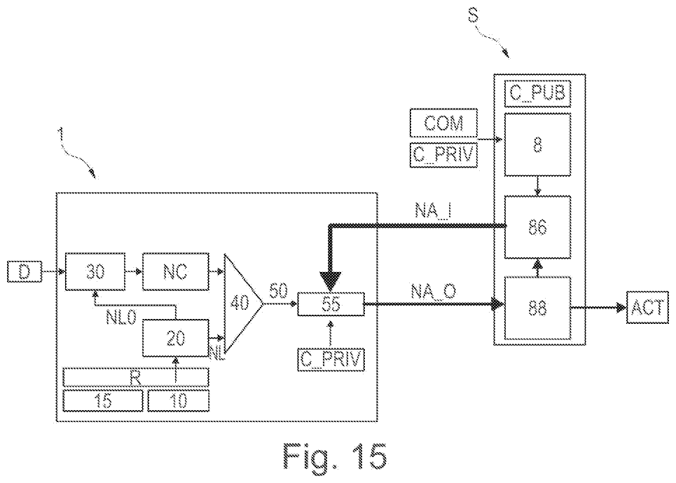

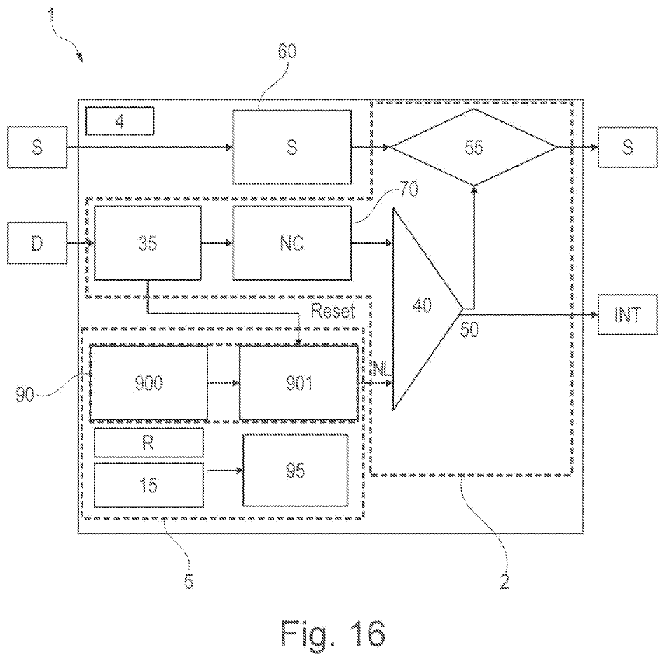

In the exemplary embodiment illustrated in FIG. 16, the integrated circuit 1 comprises a component that changes over time 5 comprising a radioactive source R used as an energy source for supplying power to a clock circuit 90.

As described above, the radioactive source R is for example deposited on a PIN diode 15, which is itself connected to a power supply module 95. This assembly provides a regulated voltage to the whole integrated circuit, or only to the clock circuit 90.

The clock circuit 90 comprises an oscillator 900, for example an RC oscillator, based on quartz or an MEMS, and a counter 901 that counts pulses.

The integrated circuit 1 furthermore comprises a computing circuit 35 that takes a period D decided on by the user at input and transforms this period D, for example expressed in seconds or indicated with a target date by providing the real date, into a target count value NC based on the frequency of the oscillator. The oscillator 900 is for example an RC oscillator with a frequency of around 12 Hz, this being able to be obtained beforehand during calibration in the factory, and stored in a non-volatile memory. Thus, for such a frequency and a period D of 10 years, the counter 901 is capable of counting 3.78 10¹² pulses, or 42 bits.

The target count value NC is stored in a non-volatile memory 70.

The counter 901 has a zero reset that will be activated at the time when the period D is programmed.

The integrated circuit 1 may have, as shown in FIG. 16, an external output INT the state of which changes as soon as the period D has elapsed. This output is for example connected to an “interrupt” input of an external microcontroller.

Of course, the invention is not limited to the examples that have just been described.

It is possible for example to divide the secret S into multiple parts in order to make it less vulnerable. These parts may be distributed among separate circuits, or else disclose the secret gradually by making the reading of the various parts dependent on the elapsing of different periods.

It is also possible to use cryptography algorithms known from the prior art, such as Shamir's Secret Sharing, in order to secure access to the secret S.

1. A programmable integrated circuit, comprising:
at least one component that changes over time, changing autonomously within the integrated circuit, as a function of the time that has elapsed since an initialization phase of the integrated circuit, this change taking place by virtue of an internal radioactive source,
at least one control circuit sensitive to the temporal change of said component and having at least one protected internal output that changes state only after a programmable predefined duration has elapsed since the initialization phase of the integrated circuit.

2. The integrated circuit as claimed in claim 1, comprising at least one protected memory read access to which is possible only when the internal output of the control circuit is in a predefined state.

3. The circuit as claimed in claim 2, the control circuit comprising:
at least one readout circuit for reading the radioactivity level of the source,
at least one comparator for comparing the read radioactivity level with a target level and generating a change of state of the protected internal output only when the radioactivity level is below the target level, due to the natural decrease in the activity of the source.

4. The integrated circuit as claimed in claim 3, the component that changes over time comprising a diode that is subjected to the radiation from the source.

5. The integrated circuit as claimed in claim 4, the radioactive source being deposited on the diode.

6. The circuit as claimed in claim 3, the control circuit comprising a computing circuit for computing the target level from a date or duration given at input and the level of the source at the time when the target level is defined.

7. The circuit as claimed in claim 3, comprising
at least a first and second radioactive sources,
a first control circuit comprising:
at least one readout circuit for reading the radioactivity level of the first radioactive source,
at least one comparator for comparing the read radioactivity level with a first target level and authorizing a change of state of a first internal output only when the read radioactivity level is below the first target level, due to the natural decrease in the activity of the first source,
a second control circuit comprising:
at least one readout circuit for reading the radioactivity level of the second source,
at least one comparator for comparing the read radioactivity level with a second target level and authorizing a change of state of a second internal output only when the read radioactivity level is below the second target level, due to the natural decrease in the activity of the second source,
the first and second sources having different half-life durations.

8. The circuit as claimed in claim 3, comprising
a first control circuit comprising:
at least one comparator for comparing the read radioactivity level with a first target level and authorizing a change of state of a first internal output only when the read radioactivity level is below the first target level, due to the natural decrease in the activity of the source,
a second control circuit comprising:
at least one comparator for comparing the read radioactivity level with a second target level and authorizing a change of state of a second internal output only when the read radioactivity level is below the second target level, due to the natural decrease in the activity of the source.

9. The circuit as claimed in claim 3, comprising:
at least one comparator for comparing the read radioactivity level with a first target level and generating a corresponding internal output,
at least one comparator for comparing the read radioactivity level with a second target level and generating a corresponding internal output,
the control circuit being designed to authorize a predefined action only when the internal outputs of the first and second comparators are in predefined states.

10. The circuit as claimed in claim 3, the radioactive source also being used to supply power to the integrated circuit, or the latter comprising a radioactive source intended to supply electric power thereto.

11. The integrated circuit as claimed in claim 1, said component comprising:
at least one internal energy source using the radiation produced by the radioactive source,
at least one clock circuit supplied with power by the internal energy source.

12. The circuit as claimed in claim 11, the control circuit comprising a computing circuit for converting a date or a period at input into a corresponding reference number of pulses of the clock circuit, the clock circuit being designed to count the number of clock pulses that have elapsed since the initialization phase, the control circuit comparing the elapsed number of pulses with the reference number.

13. The circuit as claimed in claim 1, comprising a fuse for deactivating at least one input of the circuit for programming the predefined duration.

14. The circuit as claimed in claim 1, the radioactive source being ⁶³Ni.

15. A method for protecting information for a predefined duration using an integrated circuit as claimed in claim 2, comprising the steps of:
encrypting the information so as to allow it to be decrypted only in the presence of at least one decryption key;
storing said decryption key as a secret in the protected memory of the integrated circuit,
programming said circuit with the predefined duration.

16. A method for performing a predefined action after a period or a programmed date, comprising the following steps:
storing, in an integrated circuit as claimed in claim 1, a period or a date or a corresponding target level after which an action should be performed,
performing said action when the internal output of the circuit changes state once the date has been reached or the period has elapsed and/or the read radioactivity level has crossed the corresponding target level.

17. The method as claimed in claim 16, wherein a user of the circuit is authenticated by checking the correspondence between a public key stored on the circuit and a private key held by the user, and wherein, based on the result of this check, programming of the circuit is or is not authorized.

18. The method as claimed in claim 16, wherein the integrated circuit receives a request and processes this request based on the state of the internal output, and returns a corresponding number that authenticates it for as long as the internal output is in a predefined state.

19. The method as claimed in claim 16, wherein the target level is determined using computing means external to the integrated circuit.

20. The method as claimed in claim 16, the predefined action being the activation of a bank card or another chip card, so as to allow this card to be used by a user only after a predefined period or date and/or before a predefined period or date.

21. The method as claimed in claim 16, the predefined action being an action of activating an application loaded into an electronic device, in particular a mobile telephone, so as to allow this application to be used by a user only after a predefined period or date.

22. A method for generating a blockchain, in which at least one action of validating a block depends on a predefined duration having elapsed within a circuit as defined in claim 1.
